(19) United States
(12) Patent Application Publication
(10) Pub. No.: US 2025/0308756 A1
(43) Pub. Date: Oct. 2, 2025

(54) COIL COMPONENT

(71) Applicant: TAIYO YUDEN CO., LTD., Tokyo (JP)

(72) Inventor: Masashi SHITARA, Tokyo (JP)

(21) Appl. No.: 19/078,811

(22) Filed: Mar. 13, 2025

(30) Foreign Application Priority Data
Mar. 28, 2024 (JP) 2024-054542

(51) Int. Cl. H01F 27/29

(52) U.S. Cl. CPC H01F 27/292

(57) ABSTRACT

A coil component includes: a base containing metal magnetic particles and a resin, a coil conductor provided inside the base, an external electrode provided on a surface of the base so as to be electrically connected to the coil conductor, and ceramic particles provided between the base and the external electrode.

### CROSS-REFERENCE TO RELATED APPLICATIONS

Priority is claimed to Japanese Patent Application No. 2024-054542, filed Mar. 28, 2024, the entire content of which is incorporated herein by reference.

### BACKGROUND

### 1. Technical Field

The present disclosure relates to a coil component.

### 2. Description of Related Art

A coil component is mounted in various electronic devices and is used in, for example, power supply circuits, such as DC/DC converters. A coil component includes a base, a coil conductor provided inside the base, and an external electrode provided on a surface of the base.

As a base in a coil component, a metal composite-type base is known. The metal composite-type base includes a large number of metal magnetic particles and a resin binder that binds the metal magnetic particles.

### SUMMARY

According to an aspect of the present disclosure, a coil component includes: a base containing metal magnetic particles and a resin, a coil conductor provided inside the base, an external electrode provided on a surface of the base so as to be electrically connected to the coil conductor, and ceramic particles provided between the base and the external electrode.

### BRIEF DESCRIPTION OF THE DRAWINGS

FIG. 1 is a perspective view illustrating a coil component according to an embodiment of the present disclosure;

FIG. 2 is a sectional view taken along line I-I of FIG. 1;

FIG. 3 is a sectional view taken along line II-II of FIG. 2;

FIG. 4 is an enlarged view of portion III of FIG. 2;

FIG. 5 is a diagram illustrating a configuration according to the prior art, corresponding to FIG. 4; and

FIG. 6 is a view corresponding to FIG. 4 and illustrating a modified example.

### DETAILED DESCRIPTION

In a configuration having a composite-type base, it has been pointed out that adhesion between the base and an external electrode arranged on the surface of the base tends to be low due to the presence of a resin component in the base. Therefore, in a coil component having a composite-type base, it is required to improve the adhesion between the base and the external electrode.

According to the present disclosure, adhesion between a base and an external electrode in a coil component including a composite-type base can be improved.

Hereinafter, embodiments of the present disclosure will be described in detail, but the present disclosure is not limited thereto. In the present specification and the drawings, components having substantially the same functional configuration are denoted by the same reference numerals, and redundant description thereof may be omitted. The drawings are schematic views for easy understanding of the description of the present disclosure, and are not necessarily drawn to scale. In the drawings, an L axis, a W axis, and an H axis orthogonal to each other are appropriately illustrated as axes defining a fixed coordinate system fixed to the coil component.

### Basic Structure of Coil Component

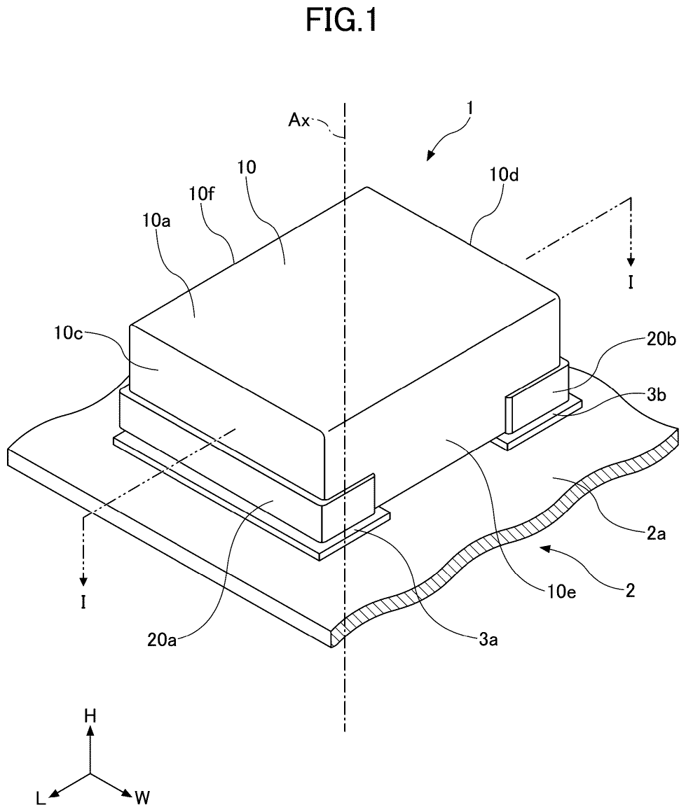

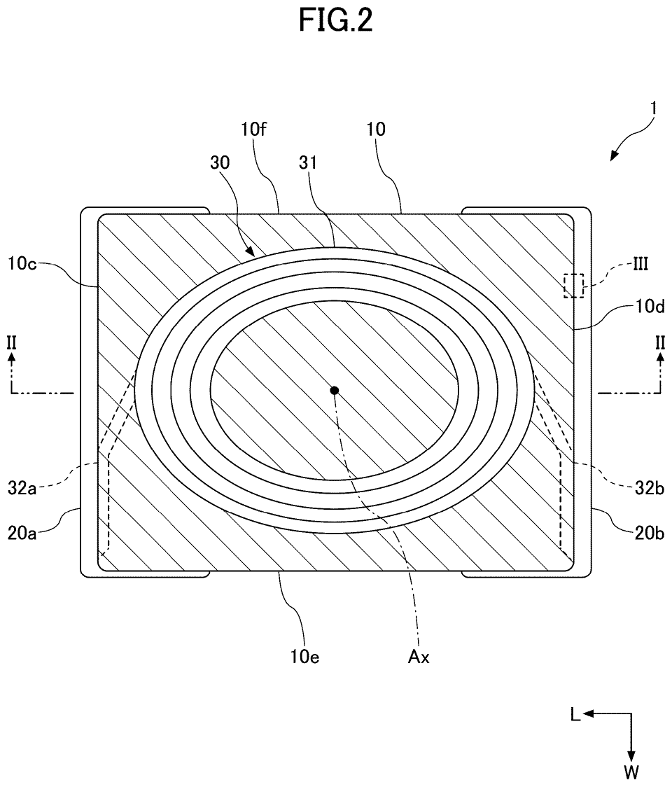

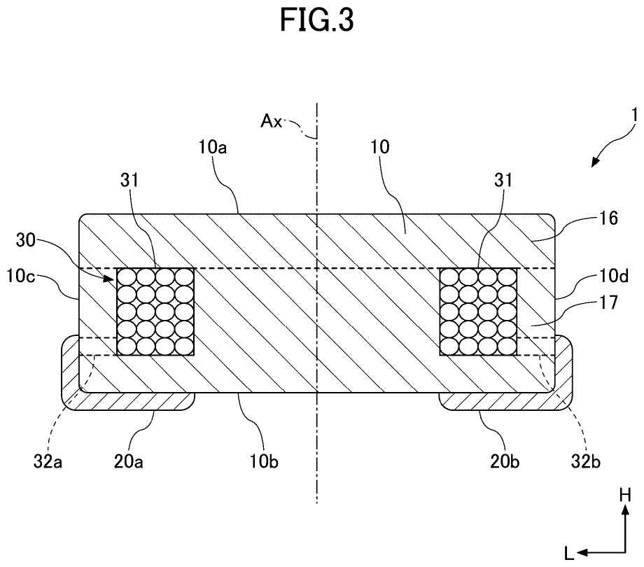

First, a basic structure of a coil component 1 according to an embodiment of the present disclosure will be described with reference to FIGS. 1 through 3. FIG. 1 is a perspective view of a coil component 1 according to an embodiment of the present disclosure. FIG. 2 is a cross-sectional view taken along line I-I of FIG. 1, and FIG. 3 is a cross-sectional view taken along line II-II of FIG. 2. The coil component 1 illustrated in FIGS. 1 through 3 is an inductor, and can be used as a power inductor incorporated in a power supply line or other various inductors. In the drawings, an L axis, a W axis, and an H axis orthogonal to each other are illustrated as appropriate. The L axis, the W axis, and the H axis define a fixed coordinate system fixed with respect to the coil component 1.

As illustrated in FIGS. 1 through 3, the coil component 1 includes a base 10 and an external electrode 20 provided on an outer surface of the base 10. The external electrode 20 includes a first external electrode 20a and a second external electrode 20b arranged separately from each other. Furthermore, in the coil component 1, as illustrated in FIGS. 2 and 3, a coil conductor 30 is provided inside the base 10.

As illustrated in FIG. 1, the coil component 1 is configured to be mounted on a mounting board 2a. The mounting board 2a is provided with land parts 3a and 3b at respective positions. The external electrode 20a is bonded to the land part 3a, and the external electrode 20b is bonded to the land part 3b, whereby the coil component 1 is mounted on the mounting board 2a.

The circuit board 2 includes the coil component 1 and the mounting board 2a on which the coil component 1 is mounted. The circuit board 2 may include various electronic components other than the coil component 1. The circuit board 2 can be mounted on various electronic devices. Examples of such electronic devices include smartphones, tablets, game consoles, servers, and electrical components of automobiles.

As illustrated in FIG. 1, the base 10 has a substantially rectangular parallelepiped shape. The base 10 includes a first main surface 10a, a second main surface 10b, a first end surface 10c, a second end surface 10d, a first side surface 10e, and a second side surface 10f. The outer surface of the base 10 is defined by these six surfaces. The first main surface 10a and the second main surface 10b face each other, the first end surface 10c and the second end surface 10d face each other, and the first side surface 10e and the second side surface 10f face each other. The outer edge of the first main surface 10a is defined by four sides. In the embodiment illustrated in FIGS. 1 through 3, the outer edge of the first main surface 10a is defined by a pair of short sides and a pair of long sides. Similarly to the first main surface 10a, the outer edge of the second main surface 10b is defined by a pair of short sides and a pair of long sides. The first end surface 10c connects the short side of the first main surface 10a and the short side of the second main surface 10b. The first side surface 10e connects a long side of the first main surface 10a and a long side of the second main surface 10b.

In FIG. 1, the first main surface 10a is located in the upper side of the base 10, and therefore, the first main surface 10a may be referred to as an “upper surface”. Similarly, the second main surface 10b may be referred to as a “lower surface”. The coil component 1 is arranged in such a manner that the second main surface 10b faces the mounting board 2a, and thus the second main surface 10b may be referred to as a “mounting surface”. The vertical direction of the base 10 is also referred to as a “height direction”, and is set to an H-axis direction in the drawings. The longitudinal direction of the base 10 is also referred to as a “lengthwise direction”, and is set to an L-axis direction in the drawings. Further, a direction orthogonal to both a heightwise direction (H-axis direction) and a lengthwise direction (L-axis direction) is referred to as a “widthwise direction”, and is set as a W-axis direction in the drawings.

In the embodiment illustrated in FIGS. 1 through 3, the surfaces 10a through 10f of the base 10 are illustrated as flat surfaces, but the surfaces 10a through 10f may be curved surfaces. Although the surfaces 10a through 10f are illustrated as being orthogonal to the adjacent surfaces, the surfaces 10a through 10f may not be orthogonal to the adjacent surfaces. Each vertex of the base 10 may be rounded, and a ridge line of the base 10 (a line indicating a boundary between adjacent surfaces among the surfaces 10a through 10f) may not be a straight line but may be curved according to the shape and arrangement of each of the surfaces 10a through 10f.

The coil component 1 can be a small coil component. The coil component 1 can be formed so that, for example, a lengthwise dimension (a dimension in the L-axis direction) is 0.2 mm or more and 4.0 mm or less, a widthwise dimension (a dimension in the W-axis direction) is 0.1 mm or more and 4.0 mm or less, and a heightwise dimension (a dimension in the H-axis direction) is 0.1 mm or more and 4.0 mm or less. In this way, the coil component 1 may be configured such that the lengthwise dimension is larger than the widthwise dimension.

In the case where the lengthwise dimension of the coil component 1 is larger than the widthwise dimension, the L-axis direction may be referred to as the “long-side direction” of the coil component 1, and the W-axis direction may be referred to as a “short-side direction” of the coil component 1. The dimension of the coil component 1 in the short-side direction may be 3.0 mm or less. At least one of the lengthwise dimension, the widthwise dimension, or the heightwise dimension of the coil component 1 may be 4.0 mm or less, 20 mm or less, 1.0 mm or less, or 0.65 mm or less. The coil component 1 may be thin, and specifically, the lengthwise dimension of the coil component 1 may be larger than the heightwise dimension. The lengthwise dimension of the coil component 1 may be twice or more the heightwise dimension, or may be three times or more the heightwise dimension. The heightwise dimension of the coil component 1 may be equal to or less than 1 mm. These dimensions of the coil component 1 are merely examples, and the coil component 1 according to the present embodiment can have any dimensions.

### Coil Conductor

The coil conductor 30 includes a wound part 31 extending along the circumferential direction around an axis Ax, which is the central axis of the coil component 1, and a lead-out part 32 led out from the wound part 31 and connected to the external electrode 20. The lead-out part 32 includes a lead-out part 32a that is led out from one end of the wound part 31 and connected to the first external electrode 20a, and a lead-out part 32b that is led out from the other end of the wound part 31 and connected to the second external electrode 20b.

In the embodiment illustrated in FIGS. 1 through 3, the coil conductor 30 is provided inside the base 10. In other words, the wound part 31, which is a part of the coil conductor 30, is embedded in the base 10. The lead-out parts 32a and 32b are connected to the coil conductor 30, and the distal ends thereof are each led out to the outside of the base 10 from any of the second main surface 10b, the first end surface 10c, and the second end surface 10d. In FIGS. 2 and 3, as an example, the lead-out parts 32a and 32b are exposed to the outside of the base 10 from the first end surface 10c and the second end surface 10d. The lead-out part 32a is connected to the external electrode 20a at the end surfaces exposed from the base 10, and the lead-out part 32b is connected to the external electrode 20b at the end surfaces exposed from the base 10.

The axis Ax of the coil component 1 is a virtual axis extending in a direction intersecting the first main surface (upper surface) 10a and the second main surface (lower surface) 10b, and is an axis extending in the height direction (H-axis direction) in the drawings. The axis Ax may be, for example, an axis extending along a straight line passing through a geometric center of gravity when the first main surface (upper surface) 10a of the coil component 1 is viewed in the H-axis direction and a geometric center of gravity when the second main surface (lower surface) 10b of the coil component 1 is viewed in the H-axis direction.

In the embodiment illustrated in FIGS. 1 through 3, the wound part 31 has a so-called horizontal winding structure in which the wound part 31 winds along the first main surface (upper surface) 10a or the second main surface (lower surface) 10b of the coil component 1. However, the wound part 31 may have a so-called vertical winding structure, in which the wound part 31 winds along the first end surface 10c or the second end surface 10d of the coil component 1 or along the first side surface 10e or the second side surface 10f of the coil component 1. The wound part 31 may have a single-phase structure formed of one wound part, or may have a multilayer structure formed by stacking a plurality of winding wound parts as in the form illustrated in FIGS. 1 through 3.

The number of turns of the coil conductor 30 in the wound part 31 is not particularly limited and may be one or more. In the case where the lead-out part 32 is provided at positions facing each other around the wound part 31, the wound part 31 includes less than one turn, that makes the total number of turns 1.5 turns or 2.5 turns, for example.

The coil conductor 30 can be formed of a material having excellent conductivity such as copper (Cu), silver (Ag), or gold (Au). The surface of the coil conductor 30 may be covered with an insulating coating. The insulating coating that covers the coil conductor 30 may contain, for example, a thermosetting resin having excellent insulating properties. Examples of the resin used for the insulating film include polyurethane, polyamide-imide, polyimide, polyester, and polyester-imide.

### Base

The base 10 may be a metal composite base formed of a composite magnetic material. The metal composite type base 10 is obtained by, for example, pressure-molding a slurry, granules, or pellets obtained by kneading a composite magnetic material containing metal magnetic particles and a resin as a binder. Therefore, the base 10 in the present embodiment contains metal magnetic particles and a resin binder. In other words, the base 10 is formed by connecting a plurality of metal magnetic particles with a resin, and the metal magnetic particles are bonded by the resin.

The metal magnetic particles contained in the base 10 may be one kind of metal magnetic particles or a mixture of a plurality of kinds of metal magnetic particles. Examples of the metal magnetic particles contained in the base 10 include metal particles such as iron (Fe) and nickel (Ni); crystal alloy particles such as Fe—Si—Cr alloy, Fe—Si—Al alloy, and Fe—Ni alloy; and amorphous alloy particles such as Fe—Si—Cr—B—C alloy and Fe—Si—Cr—B alloy. Furthermore, examples of the metal magnetic particles contained in the base 10 include Co—Nb—Zr alloy, Fe—Zr—Cu—B alloy, Fe—Si—B alloy, Fe—Co—Zr—Cu—B alloy, Ni—Si—B alloy, and Fe—Al—Cr alloy. The metal magnetic particles contained in the base 10 may contain P. These metal magnetic particles can be used singly or as mixed particles by mixing two or more kinds thereof.

In the case where the metal magnetic particles contained in the base 10 are Fe-based metal magnetic particles, the metal magnetic particles may contain Fe in an amount of 80 wt % or more. An insulating film may be formed on the surface of each of the metal magnetic particles. The insulating film may be an oxide film formed by oxidation of a metal element contained in the metal magnetic particles. The insulating film provided on the surface of each of the metal magnetic particles may be a silicon oxide film. The silicon oxide film can be formed by coating the surface of the metal magnetic particles using, for example, a sol-gel method.

The average particle diameter of the metal magnetic particles contained in the base 10 may be preferably 1 μm or more and 60 μm or less. The metal magnetic particles may have a certain degree of particle size distribution.

The particle size distribution and the average particle diameter of the particles contained in the coil component 1 can be measured and calculated by an image analysis method. For example, a cross section of a portion including the particles is exposed and photographed by a scanning electron microscope (SEM). Based on the obtained SEM image, for example, the area-based particle size distribution of the maximum particle size is obtained, and based on this particle size distribution, a mean particle size, for example, a median diameter (D50) is calculated. The maximum particle size is a maximum length of the observed particle, and may be, for example, a major axis diameter. Therefore, for example, in the case of the metal magnetic particles, the median diameter (D50) calculated from the particle size distribution of the metal magnetic particles obtained based on the SEM image can be used as an average particle size of the metal magnetic particles. The particles included in the coil component 1 are constituent particles of the coil component 1, and include the metal magnetic particles in the base 10, particles other than the metal magnetic particles included in the base 10, and ceramic particles (described later) provided between the base 10 and the external electrode 20.

The content of the metal magnetic particles in the base 10 may be 85 vol % or more, or may be 87 vol % or more. In the case where the base 10 contains a plurality of types of metal magnetic particles, the content of the metal magnetic particles means the total content of the plurality of types of metal magnetic particles.

The resin included in the base 10 may include, for example, a thermosetting resin having excellent insulation properties. Examples of the resin contained in the base 10 include an epoxy resin, a polyimide resin, a polystyrene (PS) resin, a high-density polyethylene (HDPE) resin, a polyoxymethylene (POM) resin, a polycarbonate (PC) resin, a polyvinylidene fluoride (PVDF) resin, a phenol resin, a polytetrafluoroethylene (PTFE) resin, and a polybenzoxazole (PBO) resin. These resins may be used alone or in combination of two or more.

The base 10 may further contain inorganic particles other than the metal magnetic particles. Such inorganic particles contained in the base 10 may be SiO₂ particles (silica particles), Al₂O₃ particles, glass-based particles, particles made of other inorganic materials, or a mixture of two or more kinds of these particles. The inorganic particles contained in the base 10 enter the gaps between the metal magnetic particles, and the arrangement of the metal magnetic particles can be stabilized. Therefore, the mechanical strength of the base 10 containing the inorganic particles can be improved. Such inorganic particles are embedded in the base 10 and are not substantially exposed on the surface of the base 10. The average particle diameter of the inorganic particles may be, for example, 0.01 μm or more and 1 μm or less.

### External Electrode

The external electrode 20 is electrically connected to the coil conductor 30. More specifically, the first external electrode 20a is electrically connected to the wound part 31 of the coil conductor 30 via the lead-out part 32a, and the second external electrode 20b is electrically connected to the wound part 31 of the coil conductor 30 via the lead-out part 32b. Therefore, the external electrode 20 is arranged on the surface from which the lead-out part 32 of the coil conductor 30 is led out. In the embodiment illustrated in FIGS. 1 through 3, the lead-out parts 32a and 32b of the coil conductor 30 are led out to the first end surface 10c and the second end surface 10d, respectively. Therefore, the first external electrode 20a is arranged at least on the first end surface 10c so as to include the exposed position of the lead-out part 32a on the surface of the base 10. The second external electrode 20b is arranged at least on the second end surface 10d so as to include the exposed position of the lead-out part 32b on the surface of the base 10. The ceramic particles 50 are not present between the external electrode 20 and the lead-out part 32 of the coil conductor 30.

In FIG. 1, the first external electrode 20a is arranged not only on the first end surface 10c from which the lead-out part 32a of the coil conductor 30 is led out, but also on the second main surface (lower surface) 10b, the first side surface 10e, and the second side surface 10f. Similarly, the second external electrode 20b is arranged not only on the first end surface 10c from which the lead-out part 32b of the coil conductor 30 is led out, but also on the second main surface (lower surface) 10b, the first side surface 10e, and the second side surface 10f. As described above, the external electrode 20 has a shape continuously extending over two adjacent surfaces of the base 10 or over a ridge line formed by two surfaces being in contact with each other, and further continuously extending over four surfaces including two adjacent vertices of the rectangular parallelepiped shape of the base 10, and thus the external electrode 20 is less likely to be detached from the surface of the base 10.

However, the arrangement of the external electrode 20 on the surface of the base 10 is not limited to the example illustrated in FIGS. 1 through 3. For example, the external electrode 20 may be arranged so as to be in contact with only the first end surface 10c of the base 10 and not to be in contact with the other surfaces of the base 10. In other words, the external electrode 20 may not continuously extend over a plurality of surfaces of the base 10, but may be arranged on only one surface of the base 10. The configuration in which the external electrode 20 is arranged on only one surface of the base 10 or on a plurality of adjacent surfaces of the base 10 for a smaller thickness is preferable in that the external electrode 20 can be reduced in size, which contributes to the miniaturization of the coil component 1, in that the process of forming the external electrode 20 in the manufacture of the coil component 1 can be simplified, and in that the absence of electrodes on the side surfaces eliminates the risk of short-circuiting with adjacent components and facilitates high-density mounting.

The external electrode 20 may include a metal layer (metal foil) formed by applying a conductive paste to the surface of the base 10 by screen printing or the like and heating the applied conductive paste. The thickness of such a metal layer is not particularly limited, but may be, for example, 1 μm or more and 5 μm or less. The conductive paste may include a conductive material having excellent conductivity, such as silver (Ag), palladium (Pd), copper (Cu), aluminum (Al), nickel (Ni), and alloys thereof. The content of metals in the metal layer can be, for example, 90 to 99 vol %. The external electrode 20 may include a plating layer. The plating layer may be a plurality of layers of two or more layers. In the case where the plating layer is composed of two layers, the configuration of each layer is not particularly limited, but may include, for example, a Cu plating layer, an Ag plating layer, or an Ni plating layer, and an Sn plating layer arranged further outside (on the side farther from the metal layer). The thickness of the plating layer may be, for example, 2 μm or more and 5 μm or less. In the case where the external electrode 20 includes the metal layer and the plating layer, the thickness of the external electrode 20 may be, for example, about 3 μm or more and about 10 μm or less.

The external electrode 20 may include a conductive resin layer instead of or in addition to the above-described metal layer. The conductive resin layer is made of a composite material in which conductive particles, such as metal particles, are dispersed in a resin material. It is preferable that the external electrode 20 include a conductive resin layer because a resin material enables improvement in the adhesion regardless of the unevenness of the surface of the base 10, absorbs an impact from the outside, and enables reduction of the stress generated in the external electrode 20.

Examples of the conductive particles contained in the conductive resin layer include highly conductive metals, such as silver (Ag), palladium (Pd), copper (Cu), aluminum (Al), nickel (Ni), and alloys thereof. Among these, any of Ag and Cu is preferable. These metals may be used alone or in combination of two or more. The shape of the conductive particles contained in the conductive resin layer is spherical, spheroidal, flat, rod-like, or the like, and it is preferable to combine the rod-like shape with a spherical shape and a flat shape. An average of the maximum particle diameter of the conductive particles is 0.1 μm or more and 10 μm or less, and an average of the minimum particle diameter of the conductive particles may be 0.05 μm or more and 1 μm or less.

The content of the conductive particles in the conductive polymer layer may be 30 vol % or more and 70 vol % or less. In this case, the remainder may be a resin. Specific examples of the resin material contained in the conductive resin layer include an epoxy resin, a phenol resin, and an acrylic resin.

### Adhesiveness Between Base and External Electrode

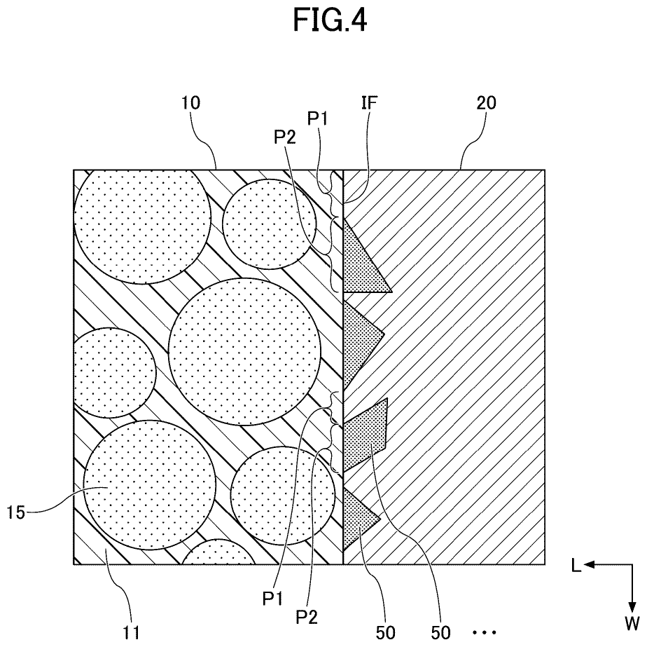

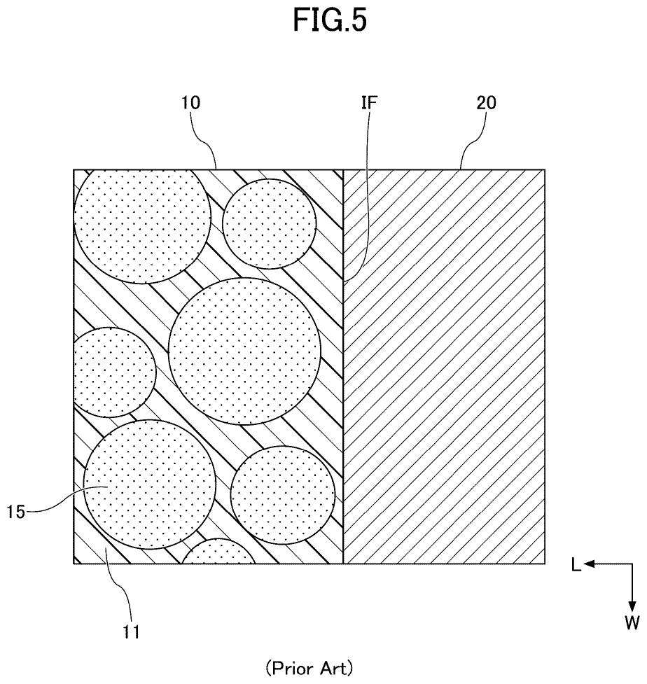

As illustrated in FIGS. 1 through 3, the external electrode 20 is provided on the surface IF of the base 10. FIG. 4 is an enlarged view of a portion III in FIG. 2. FIG. 5 illustrates a configuration according to the related art, which corresponds to FIG. 4. FIGS. 4 and 5 are microscopic views of a cross section of the base 10 and the external electrode 20, and are cross sectional views of the coil component 1 along the L-W plane, but may be cross sectional views in a direction orthogonal to the surface IF of the base 10. In the case of the present embodiment, the observation may be performed based on a cross section along the L-H plane.

As illustrated in FIG. 5, in the related art, an external electrode 20 is arranged on a surface IF of a base 10 so as to be in direct contact with the surface IF, without another layer interposed therebetween. Thus, in the related art, since only two members of the base 10 and the external electrode 20 are bonded to each other, sufficient adhesion may not be obtained between the base 10 and the external electrode 20, and the external electrode 20 may be peeled off from the surface of the base 10 due to an impact or the like. In particular, in the case where the external electrode 20 includes a metal layer, the resin of the binder included in the base 10 and the metal layer are bonded to each other, and thus the adhesion therebetween may be further reduced.

In contrast, in the embodiment of the present disclosure, as illustrated in FIG. 4, the ceramic particles 50 are provided between the base 10 and the external electrode 20 so that the ceramic particles and the external electrode 20 are in contact with the surface IF of the base 10. More specifically, the coil component 1 includes a first portion P1 where the base 10 and the external electrode 20 are in contact with each other and a second portion P2 where the ceramic particles 50 are interposed between the base 10 and the external electrode 20, and a plurality of first portions P1 are scattered. In other words, the ceramic particles 50 are arranged so as to be dispersed across the surface IF of the base 10, and the external electrode 20 covers the portion of the ceramic particles outside the surface IF of the base 10, which is not in contact with the surface IF. In the present embodiment, the presence of the ceramic particles 50 increases the adhesion between the ceramic particles 50 and the external electrode 20, and the external electrode 20 is less likely to be detached from the base 10. One of the reasons why such an effect can be obtained is considered to be that the ceramic particles 50 exhibit an anchor effect by entering at least the external electrode 20 as illustrated in FIG. 5. In the case where a force is applied to the external electrode 20 from the outside, the force is generally applied more easily in a direction along the surface of the external electrode 20, that is, in a direction along the surface of the external electrode 20 or in a direction along the surface of the base 10, than in the thickness direction of the external electrode 20. In the present embodiment, since the ceramic particles 50 are scattered across the surface IF, the adhesion strength against a force applied in a direction along the plane direction, for example, a shear direction, is particularly high, and the external electrode 20 is unlikely to be detached from the base 10.

In the present specification, the expression “scattered” ceramic particles 50 refers to a situation where the ceramic particles 50 are present in such a manner that they are separated from each other in the plane direction. In this case, the primary particles of the ceramic particles do not need to be present separately, and the primary particles or aggregates of the primary particles may be present with a space therebetween. The expression “dispersed across the surface IF” means that the ceramic particles are arranged in a direction along the surface IF and no ceramic particles are arranged in a direction intersecting the surface IF. Therefore, one ceramic particle 50 between the base 10 and the external electrode 20 is in contact with each of the base 10 and the external electrode 20. In the first portion P1 (FIG. 4) where the ceramic particles 50 are not interposed, the space between the ceramic particles 50 may be filled with the material of the base 10 and/or the external electrode 20. In other words, the ceramic particles 50 may be surrounded by the material of the base 10 and/or the external electrode 20. It is preferable that the ceramic particles 50 are not substantially present inside the base 10 and/or the external electrode 20.

In order to improve the adhesion between the base and the external electrode, it is also considered to bond the base and the external electrode by interposing an adhesive layer between the base and the external electrode. However, in the case where a small coil component is manufactured, it is difficult to accurately form an adhesive layer in a predetermined region of a part of the surface of the base. Furthermore, many adhesives are easily deteriorated by environmental changes. For this reason, the adhesive may not withstand the temperature of the firing step in the manufacturing process of the coil component, or may lose its function or adversely affect the function of the coil component due to a change in the use environment. Such a problem does not occur in the present embodiment in which the base 10 and the external electrode 20 are directly bonded to each other.

The material of the ceramic particles 50 present between the base 10 and the external electrode 20 is not particularly limited, but may be one or more selected from metal oxides, nitrides, oxynitrides, and carbides, and among these, metal oxides are preferable. This is considered to be because, in the case of a metal oxide, oxygen atoms can be exposed on the surface of the ceramic particle 50 and can form a chemical bond with the resin contained in the base 10 and, in some cases, with the resin material contained in the external electrode 20. The chemical bond may more particularly be an intermolecular bond, even more particularly van der Waals forces and/or hydrogen bonds. The ceramic particles 50 may be one or more selected from aluminum oxide, silicon oxide, titanium oxide, and zirconium oxide. Among these, aluminum oxide and silicon oxide are preferable because the central atomic radius of metal is small and the ratio of oxygen atoms exposed on the surface of the ceramic particle 50 is considered to be high. In the present embodiment, the presence of the ceramic particles 50 increases the adhesion between the base 10 and the ceramic particles 50 by the bonding between the resin contained in the base 10 and the ceramic particles 50, and the external electrode 20 is less likely to be detached from the base 10. According to the present embodiment, even if the base 10 has a surface on which a large amount of the resin 11 is present, the adhesion to the external electrode 20 can be obtained. For example, the effect can be obtained even in the case where the ratio of the area of the exposed metal magnetic particles 15 to the area of the surface of the base 10 is 20% or less, when the area of the surface of the base 10 is 100%. That is, in the coil component manufactured in this way, a large amount of the resin 11 can be present on the surface of the base 10, and the insulation resistance of the base 10 is high.

Since the external electrode 20 may include a metal layer or a conductive resin layer as described above, the case where the external electrode 20 includes a resin material as described above is the case where the external electrode 20 includes a conductive resin layer. Therefore, the case where the external electrode 20 includes a resin material as described above is the case where the external electrode 20 includes a conductive resin layer.

An average particle diameter of the ceramic particles 50 may be preferably 0.1 μm or more and 10 μm or less, and more preferably 0.5 μm or more and 5 μm or less. Having the average particle diameter of 0.1 μm or more, the ceramic particles 50 can sufficiently exhibit the above-described anchor effect. When the average particle diameter of the ceramic particles 50 is 10 μm or less, the specific surface area is increased; therefore, the number of contact points with the resin contained in the base 10 and, in some cases, the resin material contained in the external electrode 20 can be increased, and the formation of the chemical bond described above can be promoted in turn. Furthermore, the ceramic particles 50 do not hinder the thinning of the external electrode 20.

Further, when the particle size distribution of the major axis diameter of the particles on an area basis is determined by the above-described image analysis method, it is preferable that a maximum diameter of the ceramic particles 50 be 10 μm or less. This can prevent the ceramic particles 50 from affecting the thickness of the external electrode 20 and prevent the external electrode 20 from being unable to be thinned.

It is preferable that the average particle diameter of the ceramic particles 50 be smaller than the average particle diameter of the metal magnetic particles 15 contained in the base 10. This can make the ceramic particles 50 adhere to or enter the portion of the base 10 where the resin 11 is reliably present on the surface. In the step of providing the ceramic particles 50 in the manufacturing process of the coil component 1, the ceramic particles 50 are prevented from colliding with the base 10 and the metal magnetic particles 15 are prevented from being separated from the base 10.

A ratio of the average particle diameter dc of the ceramic particles 50 to the average particle diameter dm of the metal magnetic particles 15, namely dc/dm, may be preferably 0.1 or more and 0.5 or less, and more preferably 0.2 or more and 0.4 or less.

The shape of the ceramic particles 50 is not particularly limited, but the outer shape thereof is preferably non-spherical. The ceramic particles 50 preferably have a shape having a corner or a pointed portion, and more preferably have an acute angle portion, as illustrated in FIG. 4, for example. In the present specification, the shape of the ceramic particles 50 “having a corner portion” can be determined by image analysis of the ceramic particles 50. For example, an image of a cross section along a direction orthogonal to the interface between the base 10 and the external electrode 20, for example, an SEM image is taken, and the shape of the ceramic particle 50 in the cross section is extracted to observe the outline of the ceramic particle 50. Then, in the case where there is a place where the inclination of the tangent line of the contour is discontinuous, it can be determined that there is a corner portion. In the case where the angle of the corner portion of the outline of the ceramic particle 50 is less than 90°, the shape of the ceramic particle 50 can be determined as “having an acute angle portion”.

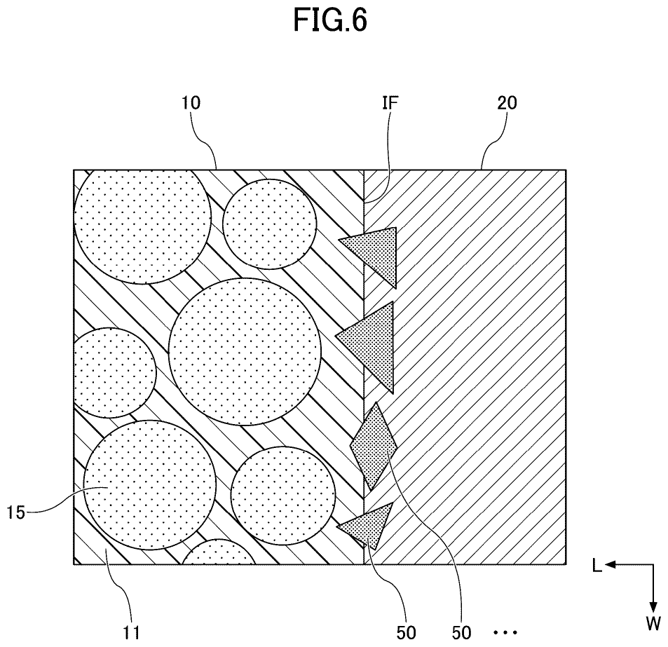

When the ceramic particles 50 have a corner, the specific surface area of the ceramic particles 50 is increased, and thus the number of chemical bonding points with the resin contained in the base 10 and, in some cases, the resin material contained in the external electrode 20 can be increased. In addition, the corner portion is likely to enter the external electrode 20 in the thickness direction of the external electrode 20 and is also likely to enter the base 10 (described later with reference to FIG. 6), and thus the above-described anchor effect is also improved. Furthermore, the ceramic particles 50 enter either the base 10 or the external electrode 20, and thus a gap is less likely to be formed between the base 10 and the external electrode 20 around the ceramic particles 50. Therefore, the adhesion between the base 10 and the external electrode 20 can be further improved.

The ceramic particle 50 preferably has a flat surface, for example, a polyhedral shape. In this case, since the ridge line is formed on the surface of the shape to form a corner portion, the corner portion is likely to enter the external electrode 20 and/or the base 10, and the above-described anchor effect is likely to be obtained.

The ceramic particles 50 are preferably crushed particles, i.e., particles produced by crushing or grinding or by machining. The crushed particles usually have corners or acute angles, and therefore, the adhesion between the base 10 and the external electrode 20 is improved as described above.

The occupied area ratio of the ceramic particles 50 in the cross section along the surface IF of the base 10, that is, the ratio of the total area occupied by the ceramic particles 50 to the area of the observed plane, may be preferably 10% or more and 50% or less, and more preferably 20% or more and 35% or less. In other words, the occupied area ratio may be considered to be the ratio of the area of the portion where the ceramic particles 50 are present in a plan view to the area of the surface of the base 10 on which the external electrode 20 is provided, when the area of the surface of the base 10 in which the external electrode 20 is provided is 100%. In the case where the occupied area ratio is 10% or more, a sufficient anchor effect is exhibited. In addition, in the case where the occupied area ratio is 50% or less, excessive concentration of the ceramic particles 50 is avoided, a favorable scattered state of the ceramic particles 50 is secured, and the entire periphery of the ceramic particles 50 can be brought into close contact with the materials of the base 10 and the external electrode 20, and thus, the adhesion between the base 10 and the external electrode 20 can be improved.

The occupied area ratio can be determined as a ratio to the length of the observation region by, for example, taking an image of a cross section along a direction orthogonal to the surface IF of the base 10 on which the external electrode 20 is provided, for example, an SEM image, and determining a total length of the ceramic particles 50 in the direction along the surface IF at the position of the surface IF in the observation region of the cross section, for example, in the same manner as the method described for measuring and calculating the average particle diameter. That is, the ratio (%) of a total length of the ceramic particles 50 along the surface IF can be obtained when the length of the observation region is set to 100%.

In the case where the external electrode 20 is a conductive resin layer, that is, a layer of a composite material in which conductive particles such as metal particles are dispersed in a resin, the conductive particles and the resin material are as described above. Here, the resin material contained in the conductive resin is more preferably a resin material having a hydroxyl group or a group capable of generating a hydroxyl group in the molecule from the viewpoint of easily forming a chemical bond with the ceramic particles 50 and improving the adhesion to the base 10. Although an epoxy resin, a phenol resin, and an acrylic resin were given as specific examples of the resin material contained in the conductive resin, an epoxy resin is preferable. Further, from the viewpoint of ensuring heat resistance as the coil component 1, for example, heat resistance of more than 100° C., the material preferably has heat resistance of 150° C. or more.

Therefore, from the viewpoint of improving the adhesion between the base 10 and the external electrode 20, it is preferable that the ceramic particles 50 include particles of at least one of aluminum oxide or silicon oxide, and the resin material included in the conductive resin be an epoxy resin. Furthermore, the resin binder contained in the base 10 is preferably an epoxy resin because the adhesion between the base 10 and the external electrode 20 is increased.

FIG. 6 illustrates a modified example of FIG. 4. In the example illustrated in FIG. 6, the ceramic particles 50 enter the resin 11 of the base 10. Thus, the ceramic particles 50 are arranged so as to span the surface IF between the base 10 and the external electrode 20 in the thickness direction of the external electrode 20. This is preferable because the ceramic particles 50 exhibit an anchor effect not only on the external electrode 20 side but also on the base 10 side, and thus the adhesion strength between the base 10 and the external electrode 20 is further improved. The configuration in which the surface IF of the base 10 is dimpled can be obtained by utilizing a process of applying motion energy to the ceramic particles 50 and causing the ceramic particles 50 to collide with the surface of the base 10 by using a sand blasting apparatus or the like in a process of attaching the ceramic particles 50 (step S20, which is described later). At this time, the ceramic particles 50 may be sprayed onto each of the bases 10, or the ceramic particles 50 may be sprayed in a batch onto the surfaces of the bases 10 that are arranged in such a manner that the surfaces to which the ceramic particles 50 are to be attached are exposed.

### Method for Manufacturing Coil Component

A method for manufacturing the coil component 1 will be described below. The method for manufacturing a coil component according to the embodiment may include a base forming step (step S10) of forming the base 10 containing the metal magnetic particles 15 and the resin 11 and having the coil conductor 30 provided in the base 10, a ceramic particle-adhering step (step S20) of adhering the ceramic particles 50 to the surfaces of the base 10, and an external-electrode-forming step (step S30) of forming the external electrode 20 on the ceramic particles 50.

In the base forming step (step S10), for example, a part of the base 10, that is, a first base part 16 (FIG. 3) is formed (step S11). A portion of the base 10 can be formed by a compression molding process. More specifically, slurry, granules, or pellets obtained by kneading a composite magnetic material containing a plurality of metal magnetic particles and a resin, which is to be the base 10, is poured into a first mold, and a molding pressure is applied to the composite magnetic material in the first mold at a temperature equal to or higher than the thermosetting temperature of the resin. The slurry for forming the base 10 may contain inorganic particles. The first base part 16 of the base containing the metal magnetic particles and the resin is obtained.

Next, the coil conductor 30 prepared in advance is placed on the first base part 16 (step S12). The coil conductor 30 may be produced by winding a metal band around a core metal using a known winding machine, such as a spindle winding machine.

Subsequently, the first base part 16 provided with the coil conductor 30 is placed in a second mold to form a second base part 17 (FIG. 3) of the base 10 (step S13). More specifically, a composite magnetic material containing metal magnetic particles and a resin, which is to be the second base part 17, is poured into the second mold, and a molding pressure is applied to the second mold. As a result, a structure including the first base part 16 and a molded body in which the coil conductor 30 is embedded in the second base part 17 is produced. The composite magnetic material used to form the second base part 17 may be the same as or different from the composite magnetic material used to form the first base part 16.

The surfaces of the cured molded body are polished (step S14) so that the first lead-out part 32a and the second lead-out part 32b of the coil conductors 30 are exposed, whereby the base 10 is formed.

Instead of the compression forming method, a warm forming method or a sheet forming method may be used for at least one of the formation of the first base part 16 (step S11) or the formation of the second base part 17 (step S13).

A specific method of the ceramic particles adhering step (step S20) is not particularly limited, but the ceramic particles adhering step can be performed by, for example, barrel processing. The barrel processing is a processing method in which the base 10 and ceramic particles are loaded into a barrel apparatus, and the barrel is rotated or shaken, or the contents of the barrel apparatus are stirred. The ceramic particles adhering step (step S20) may be performed by spraying ceramic particles onto the base 10 using a sand blasting apparatus or the like so that the ceramic particles collide with the base 10. By applying kinetic energy to the ceramic particles to cause the ceramic particles to adhere to the base 10, the surface of the resin contained in the base 10 is dimpled, and the ceramic particles can enter the resin of the base 10. This makes it possible to obtain the form described with reference to FIG. 6, and to improve the adhesion strength between the base 10 and the external electrode 20.

The conditions of the ceramic particles adhering step (step S20) can be adjusted such that the amount of the ceramic particles 50 adhering to the surface IF of the base 10 has an occupied area ratio of 10% or more and 50% or less in the coil component 1.

After the ceramic grain adhering step (step S20), in the external electrode forming step (step S30), the first external electrode 20a and the second external electrode 20b are formed on the ceramic grains adhering to the surfaces of the base 10. The first external electrode 20a can be formed so as to be electrically connected to the first lead-out part 32a of the coil conductor 30, and the second external electrode 20b can be formed so as to be electrically connected to the end portion of the second lead-out part 32b of the coil conductor 30. As described above, the external electrode 20 may include a metal layer or a conductive resin layer.

Although specific embodiments have been described in detail above, the present disclosure is not limited to the above-described embodiments. The above-described embodiments can be variously changed, modified, replaced, added, deleted, combined, and the like within the scope described in the claims.

Aspects of the present disclosure are as follows, for example.
<1> A coil component comprising: a base containing metal magnetic particles and a resin; a coil conductor provided inside the base; an external electrode provided on a surface of the base so as to be electrically connected to the coil conductor; and ceramic particles provided between the base and the external electrode.
<2> The coil component according to <1>, wherein the ceramic particles have an average maximum particle diameter of 0.1 μm or more and 10 μm or less.
<3> The coil component according to <1>or <2>, wherein the ceramic particles have an average particle diameter smaller than an average particle diameter of the metal magnetic particles.
<4> The coil component according to any one of <1> to <3>, wherein the ceramic particles are present at a ratio of 10% or more and 50% or less when an area of a surface of the base body on which the external electrode is provided is defined as 100%.
<5> The coil component according to any one of <1> to <4>, wherein the external electrode includes at least one of a metal layer or a conductive resin.
<6> The coil component according to any one of <1> to <5>, wherein the ceramic particles have a corner portion as an outer shape thereof.
<7> The coil component according to any one of <1> to <6>, wherein the external electrode has dimples on a surface facing the base so as to fit the ceramic particles.

What is claimed is:

1. A coil component, comprising:
a base containing metal magnetic particles and a resin;
a coil conductor provided inside the base;
an external electrode provided on a surface of the base so as to be electrically connected to the coil conductor; and
ceramic particles provided between the base and the external electrode.

2. The coil component according to claim 1, wherein
the ceramic particles have an average maximum particle diameter of 0.1 μm or more and 10 μm or less.

3. The coil component according to claim 1, wherein
the ceramic particles have an average particle diameter smaller than an average particle diameter of the metal magnetic particles.

4. The coil component according to claim 2, wherein
the ceramic particles have an average particle diameter smaller than an average particle diameter of the metal magnetic particles.

5. The coil component according to claim 1, wherein
the ceramic particles are present in the base at a ratio of 10% or more and 50% or less, when an area of a surface of the base where the external electrode is provided is 100%.

6. The coil component according to claim 2, wherein
the ceramic particles are present in the base at a ratio of 10% or more and 50% or less, when an area of a surface of the base where the external electrode is provided is 100%.

7. The coil component according to claim 1, wherein
the external electrode includes at least one of a metal layer or a conductive resin layer.

8. The coil component according to claim 2, wherein
the external electrode includes at least one of a metal layer or a conductive resin layer.

9. The coil component according to claim 1, wherein
the ceramic particles have a corner portion as an outer shape thereof.

10. The coil component according to claim 2, wherein
the ceramic particles have a corner portion as an outer shape thereof.

11. The coil component according to claim 1, wherein
the external electrode has dimples on a surface facing the base so as to fit the ceramic particles.

12. The coil component according to claim 2, wherein
the external electrode has dimples on a surface facing the base so as to fit the ceramic particles.
